(19) United States
(12) Patent Application Publication
(10) Pub. No.: US 2006/0206822 A1
(43) Pub. Date: Sep. 14, 2006

(54) Application communication with document embedded functions

(75) Inventor: David R. DeWitt, Livermore, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/076,619

(22) Filed: Mar. 10, 2005

(51) Int. Cl. G06F 9/00

(52) U.S. Cl. 715/733; 715/762; 715/760

(57) ABSTRACT

A document with embedded functions is provided for communications. A server application is responsible for generating a graphical user interface or other data and parses the document. Functions embedded within the document are identified. To acquire data or other information, the functions are called. For example, a function calls for text entered within a graphical user interface component. The data is obtained and inserted in the document, replacing the embedded function. As another example, the function causes the server application to acquire data for display as part of the graphical user interface. After population of data, the document is provided back to the client application.

### BACKGROUND

The present invention relates to communication or reporting of data by a computer application. In particular, a server generates data for a client application.

Applications use information for operation. For example, a server generates a graphic user interface, controlling the display and receipt of input information associated with the display. The server generates the graphic user interface in response to a different application, such as a client application on a different processor. Information associated with the graphic user interface is transmitted to the client application as needed. For example, coding associated with different graphic user interface controls are provided as part of the graphics user interface. When the user activates a control of the graphical user interface, the code packages information associated with the activation and provides the information to the client application. There is a fixed implementation relationship between the graphic user interface and the client application as a result of hard coding of the calls associated with the graphic user interface controls.

In a web browser or HTML based implementation, scripts may be used. When a graphical user interface component is selected or activated, a script, such as a java script, is activated or called. The browser then updates the graphic user interface as a function of the script. When new content is available, the server packetizes the new information and sends the information to the client application in a format set by the code or script. However, data processing and packing codes are required for each type of data packet to be communicated between the server and client applications.

### BRIEF SUMMARY

By way of introduction, the preferred embodiments described below include methods, systems, and computer readable media for communicating information, such as communicating graphical user interface information, between applications. A document with embedded functions is provided for communications. In response to a trigger, such as activation of the graphics user interface or a request from a client application, a server application responsible for generating the graphics user interface or other data parses the document. Functions embedded within the document are identified. To acquire data or other information, the functions are called. For example, a function calls for text entered within a graphics user interface component. The data is obtained and inserted in the document, replacing the embedded function. As another example, the function causes the server application to acquire data for display as part of the graphics user interface. After population of data, the document is provided back to the client application.

In a first aspect, a method is provided for communicating graphical user interface information to an application. The graphical user interface is generated. At least a first embedded function is called from a document. Data is populated in the document as a function of the embedded function. The data is responsive to the graphical user interface. The document is then communicated to a client application.

In a second aspect, a system is provided for communicating information between applications. A first processor is operable to run a client application. The client application is operable to generate a document with a plurality of embedded functions. A second processor is operable to run a server application. The server application is operable to parse the document, call each of the embedded functions, populate data into the document in response to calling the embedded functions, and communicate the document with the populated data to the client application.

In a third aspect, a computer readable storage medium has stored therein data representing instructions executable by a program processor for communicating graphical user interface information. The storage medium includes instructions for generating a graphic user interface, receiving a document with one or more embedded functions within text strings. The text strings include text other than the one or more embedded functions. Instructions are also provided for parsing the document, identifying the one or more embedded functions in the text strings. The instructions are also for implementing the one or more embedded functions without the use of the additional text. The implementation includes one or more of populating data from a graphical user interface in the document as a function of the embedded functions, updating the graphical user interface with data obtained in response to implementing one or more of the embedded functions or combinations thereof.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for communicating information between applications;

FIG. 2 is a flow chart diagram of one embodiment of a method for communicating graphical user interface information to an application;

FIG. 3 is a graphical representation of one example of a graphical user interface and associated selections;

FIG. 4 is a textual representation of one embodiment of a document with embedded functions; and

FIG. 5 is a textual representation of one embodiment of the document populated with data.

### DETAILED DESCRIPTION OF THE DRAWINGS AND PRESENTLY PREFERRED EMBODIMENTS

A predefined document, such as an XML document template, has embedded functions for retrieving data from a graphical user interface. The graphical user interface is established or controlled by a server application. The server also processes the document by calling the embedded functions. The document may be processed after the graphical user interface has been generated. The document is processed in response to entry of information associated with the graphical user interface or in response to a request from the client application. For example, the document template is maintained by the server and processed in response to each of a plurality of different requests from the same or different client applications. By calling the embedded functions, the document is populated with retrieved data. The populated document is then sent to the client application. The graphic user interface may alternatively or additionally be updated in response to the embedded functions. For example, an embedded function calls for the retrieval of data and placement of the data as part of the graphic user interface.

The document templates are predefined, so the same document may be evaluated or populated any number of times on demand. Complicated hard coding or data processing and code packing for each data packet or associated response to activation of a user interface component may be avoided. Instead, the document with embedded standard functions used by one or more servers for any client relationships is provided. Coding specific to a given graphic user interface control and an associated client application may be replaced with standardized functions for providing graphic user interface control information to the same or any of various client applications.

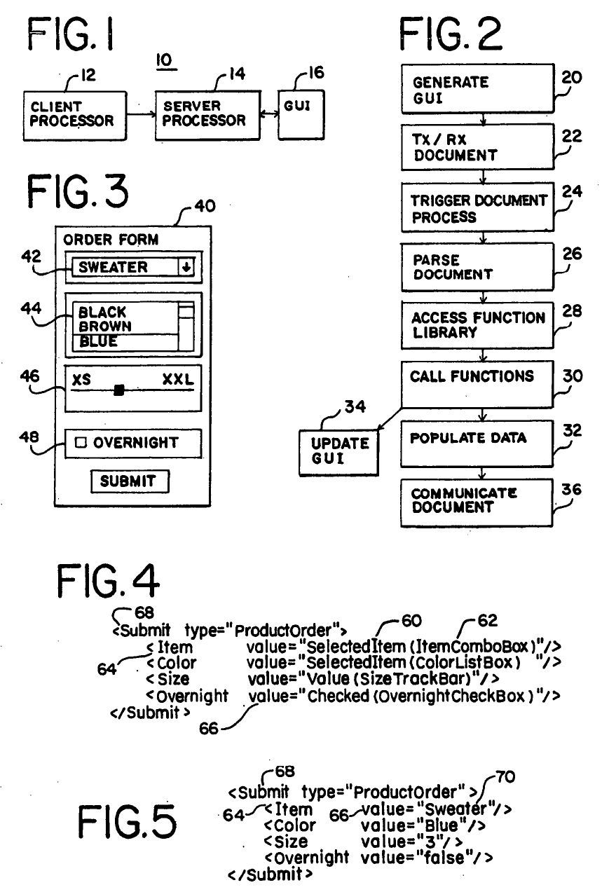

FIG. 1 shows a system 10 for communicating information between applications. The system 10 includes a client processor 12, a server processor 14 and a graphical user interface 16. Additional, different or fewer components may be provided. For example, a plurality of different client processors 12 communicate with a single server processor 14, such as disclosed in U.S. Pat. No. ______ (application Ser. No. 11/009,502 (Attorney Reference No. 2004P18664US)), the disclosure of which is incorporated herein by reference. As another example, the client processor 12 and the server processor 14 are provided without the graphic user interface 16. The system 10 operates for exchange of data associated with information other than a graphic user interface.

The client and server processors 12 and 14 are a same or different computer, server, network, general processor, application specific integrated circuit, digital signal processor, multiple processors, field programmable gate array, analog circuit, digital circuit, combinations thereof or any other now known or later developed device for running an application. In one embodiment, the client and/or server processors 12, 14 are a controller or other processor operating on an embedded system, such as a medical imaging system. For example, a control processor of a medical diagnostic ultrasound imaging system is used.

The client processor 12 is operable to run a client application. The client application is operable to generate a request for information to be served by a server application. In one embodiment, the client application is also operable to generate graphical user interface information, such as a specific request for graphic user interface components or a complete graphics user interface design or build. For example, the client application generates an HTML document or associated instructions for generating a graphics user interface. Alternatively, a client processor 12 interacts with the server processor 14 for the server processor to generate the graphics user interface 16 with or without information from the client application.

The client application is operable to generate one or more documents with a plurality of embedded functions. The document is for obtaining information about a graphics user interface or for altering a graphics user interface. For example, an extensible markup language (XML) data or other document is generated. The document includes a plurality of text strings. The document is structured as desired or appropriate for use by the client application. For example, the document provides a tree structure where each node is an element having one or more attributes. The nodes and attributes are defined by text strings. Functions may be embedded within the text strings, such as including an embedded function as a component or token within the attribute. The document is communicated to the server processor 14. Alternatively, the document is loaded onto the server processor 14 without transfer by the client application on the client processor 12.

The server processor 14 is a device for serving or running an application. In one embodiment, the server processor 14 is a processor operable to run an operating system, HTML browser, or other hardware or software for generating a display and interacting with a user input. The server processor 14 is operable to manage the graphics user interface 16. The server processor 14 is a same or different processor than used for the client processor 12. In one embodiment, the server processor 14 is embedded in a system, such as a medical imaging system. Alternatively, the server processor 14 is part of an intranet, or the Internet computer network.

The server processor 14 is operable to run a server application. The server application is a program, software, code, firmware, hardware, combinations thereof or other components for providing data or serving the client application. In one embodiment, the server application generates a graphical user interface, such as disclosed in U.S. Pat. No. ______ (application Ser. No. 11/009,502 (Attorney Reference No. 2004P18664)). For example, the server application is operable to generate a graphical user interface. The server application renders the graphical user interface from graphical user interface configuration data. A control layout description is provided by or to the server application for generating the graphic user interface. The control layout description includes a plurality of graphical user interface components, such as images, video clips, buttons, text box, drop down menus, check boxes, sliders, combinations thereof or other now known or later developed graphical user interface controls. In one embodiment, the graphical user interface components are requested or defined by the client application. The client application includes one or more labels associated with the different components. For example, a drop-down text box 42 shown in FIG. 3 is labeled. The client application provides a label associated with the drop-down text box 42, such as “item-combo-box” as shown at 62 in FIG. 4. Other characteristics of the text box 42 may be provided as well, such as a list of possible selections. As shown in FIG. 3, sweater is one selection for the text drop-down box 42. Multiple labels may be provided associated with a single graphics user interface component. Alternatively, the server application implements other processes or functions, such as imaging application, data acquisition application, data processing, searching, database management, communications, combinations thereof or other now known or later developed processes.

The graphical user interface 16 is a display, an HTML document, a collection of codes, a program, or other information for generating a graphic user interface display for use by a user. The graphical user interface 16 interacts with user input devices, such as a mouse, track ball, touch screen, capacitive sensing pad, keyboard, buttons, sliders, knobs, buttons, sensors or other user input devices. The display or display information is provided by the server application of the server processor 14 to a remote or local display for the graphical user interface 16.

The server application is operable to provide information from the graphical user interface 16 to the client processor 12 or other sources. For example, the server application receives or has stored a document with embedded functions. The server application parses the document. For example, an XML document is examined to identify one or more embedded functions or text indicating embedded functions. The server application is also operable to call each of the embedded functions. For example, a library of functions or associated codes is accessed based on identified embedded function text. The embedded functions are then activated or implemented using the associated function from the library. Data is populated into the document as a function of or in response to calling the embedded functions. For example, an embedded function requests data associated with the graphic user interface, such as data entered by a user. The server application replaces the embedded function text with the acquired data responsive to the embedded function. Once all or particular ones of the embedded functions have been called, the server application communicates the populated document to the client application. The document with the embedded functions may be processed a plurality of times, such as processing on a regular basis after generation of the graphical user interface. Any user inputs or other graphical user interface related information is then communicated to the client application using a standardized set of functions implemented in a structure or document layout defined independently of the functions or graphical user interface.

The document is processed by the server application in response to any of various triggers, such as being triggered by activation of the graphical user interface or a specific control of the graphic user interface 16, in response to other events on the server, or in response to messages or requests from clients or other processors on the network. For example, the user activates a control indicating completion of filling in a form presented on the graphical user interface 16. The document is then activated, resulting in embedded functions acquiring data entered by the user and populating the document.

The instructions for implementing processes at the client processor 12, the processes of the client application, the processes of the server processor 14, and/or the processes of the server application are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, filmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer or system.

FIG. 2 shows one embodiment of a method for communicating graphical user interface information to an application. Additional, different or fewer acts may be provided than shown in FIG. 2. For example, acts 20, 34 and/or 36 are not provided. The acts may be performed in other orders than shown. The method is implemented using the system 10 shown in FIG. 1 or a different system.

In act 20, a graphical user interface is generated. For example, a server generates a graphical user interface in response to or as a function of a layout, coding, document or other information received from a client application. Alternatively, the server generates the graphic user interface without receiving information from another application. The graphical user interface includes a plurality of components. For example, FIG. 3 shows one example of a graphical user interface display 40. The graphical user interface 40 is for an order form. A plurality of components 42, 44, 46, 48 are also included. One component is a drop-down text box 42 for allowing user selection of a plurality of predefined textual entries. Another component is a scrollable text box 44 allowing user scrolling through a list of textual selections. Another example component is a slider 46, allowing a user to indicate a position along a continuum, such as selecting a clothing article size from extra small to extra, extra large. The characteristics of any one of the components, such as the slider component 46 may alter as a function of selections made for associated components, such as the type of clothing in the drop-down text box 42. Another example component is a check box 48. Any other now known or later developed components may alternatively or additionally be provided, such as a clickable button (e.g. see the submit button), images, textual information, borders or color. Each of the components 42, 44, 46, 48 is associated with labels. For example, the drop-down text box 42 is labeled as an “itemcombobox” shown at 62 in FIG. 4. The scrollable text box 44 is labeled as a colorlistbox, the slider 46 is labeled as a sizetrackbar, and the check box 48 is labeled as an overnight check box. The label is provided by the client application or the server application for identifying a particular graphical user interface component 42-48.

In act 22, a document is transmitted by a client application and/or received by a server application. For example, the client application generates the document as a predefined template provided to the server with the graphical user interface for use after generation of the graphical user interface. As another example, the document is transmitted in response to information received from a graphical user interface, from a server application, or a trigger generated by the client application. The server application receives the document, such as loading the document from memory or receiving a transmission of the document from a different application.

The document provides a structure for formatting data and associated embedded functions. For example, the document includes text in an XML language. The XML document includes one or more embedded functions. FIG. 4 shows one embodiment of an XML document for use with the graphical user interface shown in FIG. 3. The embedded functions 60 are associated with a library of functions known to the server application or other application intended to implement the functions. The embedded functions 60 are standardized or proprietary. In FIG. 4, the embedded functions 60 include identifying a selected item, identifying a value or identifying a binary or other state of selection, such as a check.

The functions 60 also include no, one or more arguments 62. The arguments provide a context for implementing the function. For example, the argument 62 corresponds to the label used for a particular graphical user interface component 42-48. In the example of FIG. 4, the four labeled components 42, 44, 46 and 48 are each used as single arguments for four different functions 60. The argument 62 may include a function 60. For example, a function may obtain text entered in a text box with an argument that is a function for determining an identifier as of one of multiple possible text boxes. The functions may additionally or alternatively set values for the graphic user interface. For example, a function specifies text that is to be displayed in a text box. The function is provided with two arguments, one argument is a label associated with the graphical user interface component and the other argument is the data to be inserted. As another example, a function identifies a function for obtaining data to be inserted with an associated text box or other graphic user interface component provided as a second argument of the function. For example, the text of a graphical user interface component labeled time box is set using a function to acquire time from a processor operating the graphic user interface.

The functions 60 and associated arguments 62 are part of textual strings within the document that may or may not also include identifiers 64, program information 66 and/or other information. The identifiers 64 or other program information 66 are provided as part of the text strings with the function 60. The identifier 64 and program information 66 are usable by a client application but may be ignored or not used by the server application for implementing the function 60. As an XML document, the text strings are provided as element attributes of a node 68 associated with the tree structure for xml documents. In alternative embodiments, other types of documents are used, such as a data document or spread sheet.

In act 24, processing or use of the document is triggered. The triggering occurs in response to expiration of a timer, receipt of a message, or an event. The event occurs at the graphic user interface or with an application associated with the graphic user interface. For example, a user selects a submit button shown in FIG. 3 or otherwise enters information into the graphical user interface 40. In response, the document is processed. The document is processed by executing one or more embedded functions within the document. The embedded functions are executed with or without the use of other text within the document, such as not using text associated with the client application.

In act 26, the document is parsed. The server or server application parses the document's attributes. The embedded functions are identified from the text strings. For example, the server searches for the standard or known functions 60 and any associated argument 62 from the text strings of the document shown in FIG. 4, but ignores other text. Where more than one embedded function is provided, the different embedded functions are parsed or identified. The same function 60 may be identified for multiple different uses with the same or different arguments 62. A library of standard functions, a specific format or other identifier is used to parse functions 60 from the text strings within the document.

In act 28, a function library is accessed. The library includes available functions known or operable to be implemented by a given application, such as the server application. The embedded functions 60 from the document and any associated arguments 62 indicate the specific functions to be implemented and the variables to be used. The coding or processes for implementing each function are acquired from the library. For example, a function 60 “selectitem” shown in FIG. 4 is an available function within a library of functions. The argument 62 “itemcombobox” is used while calling the function.

In act 30, one or more embedded functions are called from the document. After accessing the function, the function is implemented or called. One or more functions, such as the four functions shown in FIG. 4, are called. Since the functions are from the XML or other document, the functions are called from the document. A set of functions provided from the server are used to extract data from the controls or other graphical user interface information, from other information or data from the server, or from data passed to the server by other clients. The function name specifies the type of process to be performed. The argument, such as the label, specifies a variable associated with the function, such as a location to acquire the data. Alternatively, the function has no argument, such as a function to acquire a time. Each function is called as the function is parsed from the document. Alternatively, the functions are called after the entire document has been parsed.

In act 32, the document is populated with data. As the functions embedded in the document are called, data is obtained. The data is responsive to or from the graphical user interface. The data replaces the embedded function within the document. For example, FIG. 5 shows the data 70 of sweater, blue, three, and replacing the functions 60 false shown in FIG. 4. The function 60 and argument 62 are replaced with the data acquired from the graphical user interface 40. As the document is parsed and embedded functions called, data associated with one or more of the embedded functions is packed into the document. The data comprises an output string representative of a value, variable or other information to be or placed in the document.

Act 34 is an alternative or additional act to act 32. In act 34, an embedded function is called to update the graphical user interface. The function is associated with acquiring data or data provided as an argument. The data is then used for updating the graphical user interface, such as providing a name, text, default selections or other information.

In act 36, the document is communicated. For example, the document populated with data is communicated to a client application. The client application uses the data for implementing further processes, such as an order, image acquisition configuration, or other uses. As an alternative to transmitting the document to a client application, the document is stored or otherwise used by the server.

In the embodiment above, dynamic evaluation of data from a graphical user interface is provided. In alternative embodiments, the embedded functions in a document are used for communicating between other applications without graphical user interface information. For example, one application may submit a document template to another application for processing. The document has embedded functions for extracting data from the other application. The other application evaluates the embedded functions by parsing the document and returns the populated document. The application receiving the document populates the data without knowledge of or use of other data or structure within the document. Functions which the application recognizes are called. Other functions, text or information are ignored, flagged or not used.

In the example shown in FIG. 3, a simple order form is implemented. The embedded functions within the document are used to populate the document for communicating graphic user information to another application. In other embodiments, more simple or complex graphic user interfaces may be provided. For example, a plurality of different functions for configuring an ultrasound, x-ray, positron emission, magnetic resonance, CAT scan or other medical imaging system are provided. A hierarchy or menu structure of a plurality of different pages of graphical user interface may interact together. A single trigger or multiple triggers may be provided for populating or processing one or more different document templates. For example, a different template is provided for different portions of an entire graphical user interface. Alternatively, a same template is provided for different portions of a graphical user interface which may and may not be used. Functions calling for data that is not available are populated with a default, such as no value or filler values.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(We) claim:

1. A method for communicating graphical user interface information to an application, the method comprising:
generating a graphical user interface;
calling at least a first embedded function from a first document;
populating first data in the first document as a function of the first embedded function, the first data responsive to the graphical user interface; and
communicating the first document to a client application.

2. The method of claim 1 further comprising:
triggering the calling and populating after activation of a component of the graphical user interface.

3. The method of claim 1 wherein populating comprising replacing the first embedded function with the data.

4. The method of claim 1 further comprising:
transmitting the first document with the first embedded function to a server from the client application;
wherein the server generates the graphical user interface.

5. The method of claim 4 wherein calling the first embedded function comprises calling from a library of functions available to the server, wherein the first document provides a structure and includes second data associated with the first embedded function and the server is operable to populate the data free of use of the second data.

6. The method of claim 1 wherein calling at least the first embedded function comprises calling the first, a second and at least a third embedded function, and wherein populating comprises populating first, second and at least third data in the first document as a function of the first, second and at least third embedded functions, respectively, the first, second and third data responsive to the graphical user interface.

7. The method of claim 1 wherein calling from the first document comprise calling from an XML document, the first embedded function being a text string as an element attribute.

8. The method of claim 1 wherein generating the graphical user interface comprises generating with a server in response a first label received from the client application, and wherein calling comprises calling with the first embedded function having the first label as an argument.

9. The method of claim 1 wherein generating the graphical user interface is performed prior to calling and populating.

10. The method of claim 1 wherein populating comprises parsing the first document and packing the first data from the graphical user interface into the first document.

11. The method of claim 1 further comprising:
calling a second embedded function from the first document;
updating the graphical user interface with data obtained in response to the calling of the second embedded function.

12. A system for communicating information to between applications, the system comprising:
a first processor operable to run a client application, the client application operable to generate a first document with a plurality of embedded functions; and
a second processor operable to run a server application, the server application operable to parse the first document, call each of the embedded functions, populate graphic user interface data in the first document in response to calling the embedded functions, and communicate the first document with the populated graphic user interface data to the client application.

13. The system of claim 12 wherein the client application is operable to generating graphical user interface components and the server application is operable to generate a graphical user interface in response to the graphical user interface components, the graphical user interface components including at least a first label; and
wherein after generation of the graphical user interface, the server application is operable to call with a first embedded function of the plurality of embedded functions, the first embedded function having the first label as an argument, the calling being triggered by activation of the graphical user interface, the first embedded function being from a library of functions available to the server.

14. The system of claim 12 wherein the first document comprises an XML document, the first embedded function being a text string as an element attribute.

15. A computer readable storage medium having stored therein data representing instructions executable by a programmed processor for communicating graphical user interface information, the storage medium comprising instructions for:
generating a graphical user interface;
receiving a document with one or more embedded functions within text strings, the text strings including additional text other than the one or more embedded functions;
parsing the document, the parsing identifying the one or more embedded functions from the text strings; and
implementing the one or more embedded functions without use of the additional text, the implementing comprising at least one of:
populating data from the graphical user interface in the document as a function of the one or more embedded functions;
updating the graphical user interface with data obtained in response to the implementing of the one or more embedded functions; or
combinations thereof.

16. The instructions of claim 15 wherein implementing comprises replacing the one or more embedded functions with data from the graphical user interface in the document as a function of the one or more embedded functions; and
further comprising communicating the populated document to a client application.

17. The instructions of claim 15 wherein parsing comprises identifying the one or more embedded functions within the text string, and wherein implementing comprises accessing a library of available functions and performing the available functions from the library corresponding to the one or more embedded functions identified within the text string.

18. The instructions of claim 15 wherein the document comprises an XML document, the one or more embedded functions being element attributes.

19. The instructions of claim 15 wherein generating the graphical user interface comprises generating as a function of a received first label, and wherein implementing comprises calling with the one or more embedded functions having the first label as an argument.

20. The instructions of claim 15 wherein implementing comprises updating the graphical user interface with data obtained in response to the implementing of the one or more embedded functions.

21. The instructions of claim 20 wherein updating is in response to implementing a first one of the embedded functions, the implementing further comprising populating data from the graphical user interface in the document as a function of a second one of the one or more embedded functions.

22. A method for communicating information to an application, the method comprising:
providing a first document having at least a first embedded function to a first application;
calling by the first application at least the first embedded function from the first document;
populating first data in the first document as a function of the first embedded function, the first data responsive to data associated with the first application, the first data free of graphical user interface information; and
communicating the first document to a client application.
